(19) United States
(12) Patent Application Publication
(10) Pub. No.: US 2008/0266240 A1
(43) Pub. Date: Oct. 30, 2008

(54) Apparatus and method for contrast control

(75) Inventors: Szu Ping CHEN, Jhubei City (TW); Li Chou CHEN, Jhubei City (TW); Fu Yuan SHIH, Kaohsiung City (TW)

Correspondence Address: IPR WORKS, LLC, P.O. BOX 303, ATLANTIC HIGHLANDS, NJ, 07716, US

(73) Assignee: REALTEK SEMICONDUCTOR CORP., Hsinchu (TW)

(21) Appl. No.: 12/106,307

(22) Filed: Apr. 20, 2008

(30) Foreign Application Priority Data
Apr. 27, 2007 (TW) 096114913

(51) Int. Cl. G09G 3/36

(52) U.S. Cl. 345/102

(57) ABSTRACT

An apparatus for contrast control and an associated method are provided. The apparatus can adjust the backlight brightness for a white or black frame to enhance the contrast of a display device, and keep the backlight brightness at a suitable level for other frames to avoid lowering the contrast of a single frame. The apparatus includes a frame detection unit and a backlight control unit. The frame detection unit detects whether an input frame is a white or black frame, and outputs a corresponding detection signal; the backlight control unit generates a backlight control signal according to the detection signal, thereby controlling the brightness of a backlight source of the display device.

### BACKGROUND OF THE INVENTION

(a). Field of the Invention

The invention relates to display devices, and more particularly to an apparatus and method for contrast control used in the display devices.

(b). Description of the Prior Arts

In common display devices such as LCD devices, it is desirable to achieve higher contrast so as to upgrade the specification of the display devices and bring better visual effects. In prior arts, U.S. Pat. No. 6,762,742 calculates the average gray level of a frame, and then adjusts the backlight brightness to change the frame brightness according to the average gray level, thereby improving the contrast of the display device.

Another U.S. Pat. No. 6,795,053 generates the average brightness level, the MAX brightness level and MIN brightness level of a frame, and then adjusts the backlight brightness according to these informations, thereby improving the contrast of the display device.

The above prior arts improve the contrast by adjusting the backlight brightness or frame brightness according to the calculation result of the frame signal, such as the average gray level or average brightness level of the frame. However, the adjustment of the backlight brightness may degrade the contrast of a single frame. For instance, if the single frame is black to a certain extent and the backlight brightness is adjusted to a lower level, then the contrast of the single frame will be lowered since the single frame with a lower backlight brightness has a lower contrast than that with a higher backlight brightness. Thus, the prior arts may cause a problem that the decrease of the backlight brightness degrades the contrast of the single frame.

### SUMMARY OF THE INVENTION

It is therefore one objective of the invention to provide an apparatus and method for contrast control, which can determine at least two different display settings according to the information of an input frame, thereby avoiding the problem of the prior arts.

In one embodiment of the invention, an apparatus for contrast control used in a display device is provided. The apparatus comprises: a frame detection unit for detecting whether an input frame satisfies a specific condition, and outputting a detection signal to indicate whether the input frame satisfies the specific condition; and a backlight control unit, coupled to the frame detection unit, for generating a backlight control signal according to the detection signal to control a brightness of a backlight source of the display device, wherein when the input frame satisfies the specific condition, the backlight control signal corresponds to a first display setting; when the input frame does not satisfy the specific condition, the backlight control signal corresponds to a second display setting which is different from the first display setting.

In another embodiment of the invention, a method for contrast control used in a display device is provided. The method comprises: receiving an input frame; detecting whether the input frame satisfies a specific condition and outputting a detection signal for indicating whether the input frame satisfies the specific condition; and generating a backlight control signal according to the detection signal to control a brightness of a backlight source of the display device, wherein when the input frame satisfies the specific condition, the backlight control signal corresponds to a first display setting; when the input frame does not satisfy the specific condition, the backlight control signal corresponds to a second display setting which is different from the first display setting.

### BRIEF DESCRIPTION OF THE DRAWINGS

FIG. 1 is a block diagram of an embodiment of the apparatus for contrast control according to the invention.

FIG. 2A shows an embodiment of the backlight brightness generated by the backlight source under the control of the backlight control unit of FIG. 1.

FIG. 2B shows another embodiment of the backlight brightness generated by the backlight source under the control of the backlight control unit of FIG. 1.

FIG. 3 is a block diagram of an embodiment of the display control unit of FIG. 1.

FIG. 4 shows an embodiment of how the display control unit of FIG. 3 adjusts an input frame.

FIG. 5 is a flow chart of the method for contrast control according to an embodiment of the invention.

### DETAILED DESCRIPTION OF THE INVENTION

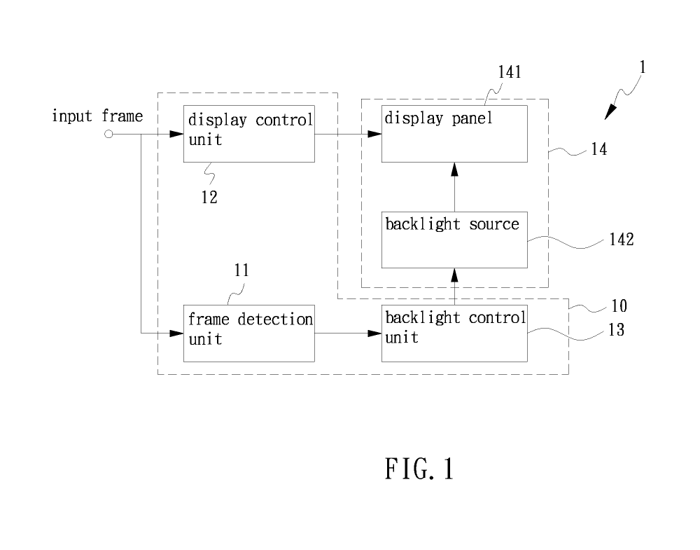

This invention discloses a display control circuit for determining at least two different display settings according to the information of an input frame. For example, as to the setting for backlight brightness, the backlight brightness is set to the maximum or minimum brightness when the information of the input frame shows that the input frame is a white frame or black frame; the backlight brightness is predetermined (e.g. determined by a user) when the information of the input frame shows that the input frame is an ordinary frame (i.e. neither white frame nor black frame). FIG. 1 is a block diagram of an embodiment of the apparatus for contrast control according to the invention. As shown, a display device 1 includes a display control circuit 10 and a display module 14. The display device 1 can be a LCD device. The display control circuit 10 includes an apparatus for contrast control 10′, which comprises a frame detection unit 11, a display control unit 12, and a backlight control unit 13. The display module 14 includes a display panel 141 and a backlight source 142.

As described above, the prior arts control the backlight brightness according to the calculation result of the frame signal (such as the average gray level or average brightness level of the frame), and thus degrades the contrast of a single frame. In particular, when the single frame is black to a certain degree, the contrast of the single frame with a lower backlight brightness will be lower than that with a higher backlight brightness. This invention employs the frame detection unit 11 to detect an input frame so as to differentiate between two different settings for backlight brightness (e.g. the setting for upgrading visual effects and the setting for contrast enhancement). In this manner, the problem of the prior arts can be avoided and the visual effects can also be maintained.

The frame detection unit 11 detects whether the input frame satisfies a specific condition and outputs a detection signal to indicate whether the input frame satisfies the specific condition. An embodiment of the specific condition is a white frame, a black frame, or one of the white frame and the black frame. The backlight control unit 13 is coupled to the frame detection unit 11, and generates a backlight control signal according to the detection signal. The backlight control signal is provided to the backlight source 142 to control the brightness thereof. The display control unit 12 adjusts the pixel values (e.g. RGB, YCbCr or YUV) of the input frame according to a default contrast curve and a statistical brightness information of the input frame. Then, the adjusted input frame is provided to the display module 14 for display. The backlight source 142 of the display module 14 adjusts its brightness according to the backlight control signal, and the display panel 141 displays the adjusted input frame with the brightness of the backlight source 142.

In one embodiment, the frame detection unit 11 includes a comparator and at least one threshold for performing a frame detection method to determine whether the input frame satisfies the specific condition. The frame detection unit 11 compares each pixel value of the input frame with a first threshold. If each pixel value is larger than or equal to the first threshold, then the input frame is determined as a white frame; otherwise, the input frame is determined as a non-white frame. On the other hand, the frame detection unit 11 further compares each pixel value of the input frame with a second threshold. If each pixel value is smaller than or equal to the second threshold, then the input frame is determined as a black frame; otherwise, the input frame is determined as a non-black frame. For instance, if the range of the pixel value is 0˜255 (0 represents all black, and 255 represents all white), then the first threshold can be set as 255 or slightly smaller than 255 (e.g. 245), and the second threshold can be set as 0 or slightly larger than 0 (e.g. 10). Thus, the detection result of the frame detection unit 11 either satisfies the specific condition (i.e. a white frame, a black frame, or one of the white frame and the black frame) or does not satisfy the specific condition (i.e. a non-white frame, a non-black frame, or a non-white and non-black frame). When the input frame satisfies the specific condition, the display setting for contrast enhancement is used, and the backlight control unit 13 outputs the corresponding backlight control signal to enhance the contrast of the input frame; when the input frame does not satisfy the specific condition, the display setting for maintaining or upgrading visual effects is used, and the backlight control unit 13 outputs the corresponding backlight control signal to maintain or upgrade the visual effects of the input frame.

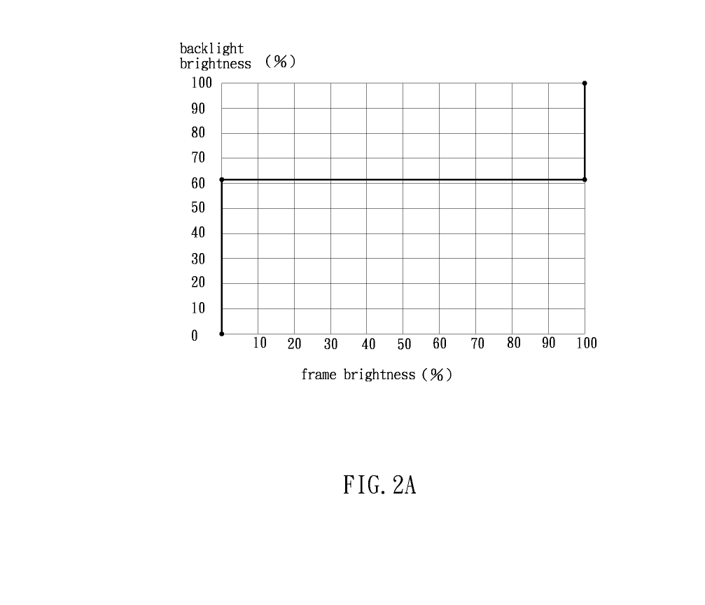

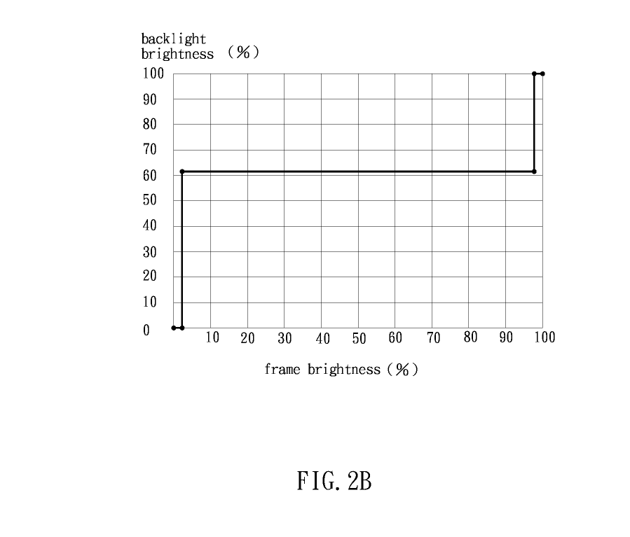

FIG. 2A shows an embodiment of the backlight brightness generated by the backlight source 142 under the control of the backlight control unit 13 of FIG. 1. In FIG. 2A, the horizontal axis represents the brightness of the input frame denoted by the percentage, where 0% and 100% represent an all-black frame and an all-white frame respectively; the vertical axis represents the brightness of the backlight source 142 denoted by the percentage, where 0% and 100% represent the minimum and maximum brightness respectively. When the frame detection unit 11 determines that the input frame is the black frame (i.e. each pixel value of the input frame is 0 when the low limit for the pixel value is 0 and the second threshold is set as 0), the detection signal is outputted to inform the backlight control unit 13, which then adjusts the backlight source 142 to the minimum brightness. In this manner, the brightness of the black frame is decreased to a minimum when it is displayed on the display panel 141. On the other hand, when the frame detection unit 11 determines that the input frame is the white frame (i.e. each pixel value of the input frame is 255 when the high limit for the pixel value is 255 and the first threshold is set as 255), the detection signal is outputted to inform the backlight control unit 13, which then adjusts the backlight source 142 to the maximum brightness. In this manner, the brightness of the white frame is increased to a maximum when it is displayed on the display panel 141. By this kind of backlight brightness adjustment, the contrast ratio (i.e. the ratio of the brightness of white frame to that of black frame) of the display device 1 is upgraded. Further, when the frame detection unit 11 determines that the input frame is neither the white frame nor the black frame, the detection signal is outputted to inform the backlight control unit 13, which then keeps the backlight source 142 at the setting for upgrading the visual effects, such as keeps at a constant brightness of 62% as shown in FIG. 2A, thereby preventing from lowering the contrast of an ordinary frame. The backlight brightness for upgrading the visual effects can be predetermined or set by a user, and it should be noted that this backlight brightness 142 is not necessarily kept at a constant level.

FIG. 2B shows another embodiment of the backlight brightness generated by the backlight source 142 under the control of the backlight control unit 13 of FIG. 1. In FIG. 2B, the first and second thresholds are set as 250 and 5 respectively. When the frame detection unit 11 determines that the input frame is the black frame (i.e. each pixel value of the input frame is smaller than or equal to 5, and the frame brightness is smaller than about 2%), the backlight source 142 is adjusted to the minimum brightness; when the frame detection unit 11 determines that the input frame is the white frame (i.e. each pixel value of the input frame is larger than or equal to 250, and the frame brightness is larger than about 98%), the backlight source 142 is adjusted to the maximum brightness.

Thus, by means of the operation of the apparatus for contrast control 10′ (i.e. increasing and decreasing the backlight brightness for the white frame and the black frame respectively, while maintaining a constant backlight brightness for other frames), the contrast of the display device 1 can be upgraded, and the contrast of a single ordinary frame (i.e. a non-white and non-black frame) can be maintained or enhanced so as to upgrade the visual effects.

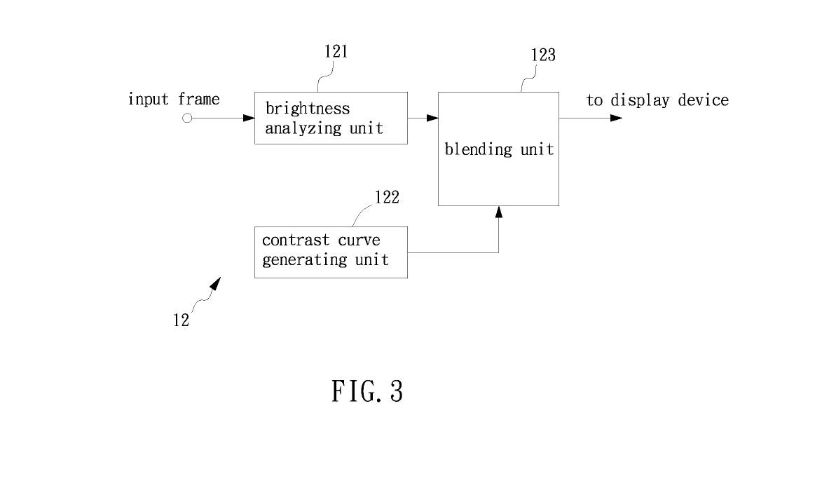

FIG. 3 is a block diagram of an embodiment of the display control unit 12 of FIG. 1, where the display control unit 12 includes a brightness analyzing unit 121, a contrast curve generating unit 122 and a blending unit 123. The brightness analyzing unit 121 analyzes the input frame to generate a statistical brightness information thereof. The statistical brightness information contains a brightness distribution curve. The contrast curve generating unit 122 provides a default contrast curve, which is a transfer curve between the input brightness and the output brightness. The default contrast curve defines the corresponding output brightness of different input brightness, and is used by the blending unit 123 for performing a weighted blending. The blending unit 123 is coupled to the brightness analyzing unit 121 and the contrast curve generating unit 122, and performs the weighted blending according to the brightness distribution curve in the statistical brightness information and the default contrast curve, thereby generating a new input-output brightness curve to adjust the input frame. After being adjusted by the blending unit 123, the input frame is sent to the display panel 141 for displaying. By the adjustment of the display control unit 12, the contrast of a single ordinary frame (i.e. a non-white and non-black frame) can be enhanced. In one embodiment, the display control unit 12 further includes a gain adjusting unit (not shown) for further adjusting the output of the blending unit 123. The gain adjusting unit can perform a Gamma correction, or upgrade the visual effects according to user operation, such as the enhancement of the image sharpness.

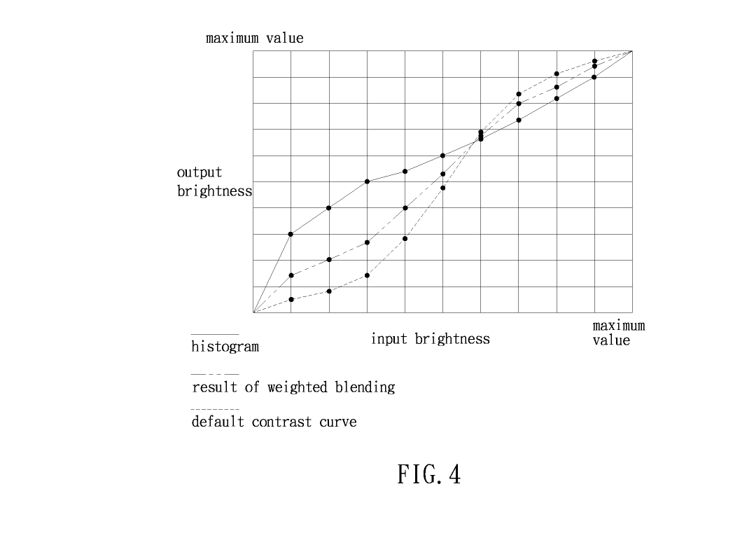

FIG. 4 shows an embodiment of how the display control unit 12 of FIG. 3 adjusts the input frame. In FIG. 4, the horizontal and vertical axes represent the input and output brightness respectively, and the three curves correspond to the statistical brightness information (i.e. brightness histogram) of the brightness analyzing unit 121, the default contrast curve of the contrast curve generating unit 122, and the result of the weighted blending of the blending unit 123. How to generate the brightness histogram of the input frame and how to perform the weighted blending are well known to the people skilled in the art, and will not be described here.

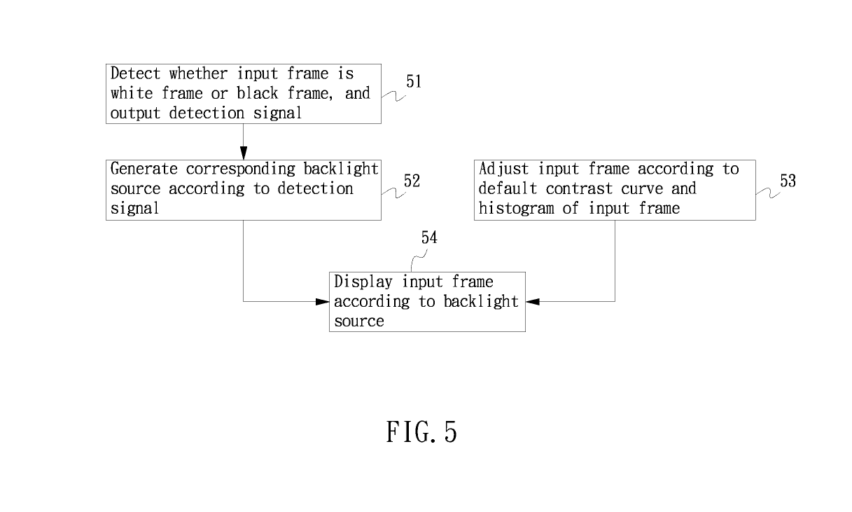

FIG. 5 is a flow chart of the method for contrast control according to an embodiment of the invention. In this embodiment, the method for contrast control is used in a display device such as a LCD device. Since the related steps of this embodiment have been described in detail as above, the description for these steps is omitted here.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. An apparatus for contrast control used in a display device, the apparatus comprising:
a frame detection unit for detecting whether an input frame satisfies a specific condition, and outputting a detection signal to indicate whether the input frame satisfies the specific condition; and
a backlight control unit, coupled to the frame detection unit, for generating a backlight control signal according to the detection signal to control a brightness of a backlight source of the display device, wherein when the input frame satisfies the specific condition, the backlight control signal corresponds to a first display setting; when the input frame does not satisfy the specific condition, the backlight control signal corresponds to a second display setting which is different from the first display setting.

2. The apparatus of claim 1, wherein the specific condition is at least one of a white frame and a black frame.

3. The apparatus of claim 1, wherein the first display setting is a setting for contrast enhancement.

4. The apparatus of claim 1, wherein the second display setting is a setting for maintaining or upgrading visual effects.

5. The apparatus of claim 2, further comprising:
a display control unit for adjusting pixel values of the input frame according to a default contrast curve and a statistical brightness information of the input frame.

6. The apparatus of claim 5, wherein the display control unit comprises:
a brightness analyzing unit for analyzing the input frame to generate the statistical brightness information;
a contrast curve generating unit for providing the default contrast curve; and
a blending unit, coupled to the brightness analyzing unit and the contrast curve generating unit, for performing a weighted blending according to the statistical brightness information and the default contrast curve.

7. The apparatus of claim 6, wherein the display control unit further comprises:
a gain adjusting unit for performing a Gamma correction on an output of the blending unit.

8. The apparatus of claim 2, wherein the backlight control unit adjusts the backlight source to a maximum brightness when the input frame is the white frame.

9. The apparatus of claim 2, wherein the backlight control unit adjusts the backlight source to a minimum brightness when the input frame is the black frame.

10. The apparatus of claim 2, wherein the backlight control unit maintains the backlight source at a predetermined brightness when the input frame is not one of the white frame and the black frame.

11. A method for contrast control used in a display device, the method comprising:
receiving an input frame;
detecting whether the input frame satisfies a specific condition and outputting a detection signal for indicating whether the input frame satisfies the specific condition; and
generating a backlight control signal according to the detection signal to control a brightness of a backlight source of the display device, wherein when the input frame satisfies the specific condition, the backlight control signal corresponds to a first display setting; when the input frame does not satisfy the specific condition, the backlight control signal corresponds to a second display setting which is different from the first display setting.

12. The method of claim 11, further comprising:
adjusting pixel values of the input frame according to a default contrast curve and a statistical brightness information of the input frame.

13. The method of claim 12, wherein the statistical brightness information comprises a brightness histogram.

14. The method of claim 12, wherein the step of adjusting pixel values of the input frame comprises:
analyzing the input frame to generate the statistical brightness information;
setting the default contrast curve; and
performing a weighted blending according to the statistical brightness information and the default contrast curve.

15. The method of claim 11, wherein the step of detecting whether the input frame satisfies the specific condition further comprising:
comparing a plurality of pixel values of the input frame with a threshold value to determine whether the input frame satisfies the specific condition.

16. The method of claim 11, wherein the specific condition is a white frame, and the backlight control unit adjusts the backlight source to a maximum brightness when the input frame is the white frame.

17. The method of claim 11, wherein the specific condition is a black frame, and the backlight control signal adjusts the backlight source to a minimum brightness when the input frame is the black frame.

18. The method of claim 11, wherein the backlight control signal maintains the backlight source at a predetermined brightness when the input frame does not satisfy the specific condition.

19. The method of claim 1I, wherein the specific condition is at least one of a white frame and a black frame.

20. The method of claim 1I, wherein the first display setting is a setting for contrast enhancement, and the second display setting is a setting for maintaining or upgrading visual effects.
